(19) United States
(12) Patent Application Publication
(10) Pub. No.: US 2013/0339484 A1
(43) Pub. Date: Dec. 19, 2013

(54) ONLINE WEB-COURSE REALITY PROGRAM

(71) Applicants: Eran POLACK, Tel Aviv (IL); Amit FARBMAN, Tel Aviv (IL)

(72) Inventors: Eran POLACK, Tel Aviv (IL); Amit FARBMAN, Tel Aviv (IL)

(73) Assignee: SCOOLTV, INC., Dover Kent, DE (US)

(21) Appl. No.: 13/526,571

(22) Filed: Jun. 19, 2012

(51) Int. Cl. G06F 15/16

(52) U.S. Cl. 709/218

(57) ABSTRACT

The subject matter discloses a method comprising conducting an online web-course between an instructor and a group of registrants; obtaining a list comprising data of the group of registrants; establishing a reality program to be broadcasted, said reality program includes two or more contestants; choosing the two or more contestants for the reality program from the group of registrants, wherein at least one of the steps is performed by a processor.

### FIELD OF THE INVENTION

The subject matter relates generally to an online web-course comprising of a class and reality program.

### BACKGROUND OF THE INVENTION

With the advancements in computer communications students have an opportunity to receive an education in a variety of subjects from classes offered online, offline, or a combination of both. Students may take single classes, to learn a single concept or subject, for example cardiopulmonary resuscitation (CPR) training. Some students may choose to obtain a technical degree to master an applied science, for example a degree in information technology. Other students may opt to receive a full academic degree, for example obtaining a bachelor's degree in business administration.

In the classroom environment students may interact with an instructor, who conveys information and the tasks required for learning the material to the students. Students are able to interact with one another, share information, and discuss the material that is being taught.

Reality programs allow individuals to be recorded and then watched by an audience. Some reality programs portray the real daily life experiences of the individuals. In reality programs portraying the daily life of the performers, the individuals appearing in the reality program are followed by the recording crew as the individuals go through their individual daily routines and habits. In other reality programs the individuals compete for the opportunity to win prizes and prestige with respect to the theme of the reality program, for example a reality program where the individuals are contestants that compete to become the best basketball player; the contestants train and then compete against each other in basketball.

### SUMMARY

The subject matter discloses a method comprising conducting an online web-course between an instructor and a group of registrants; obtaining a list comprising data of the group of registrants;

establishing a reality program to be broadcasted, said reality program includes two or more contestants; choosing the two or more contestants for the reality program from the group of registrants, wherein at least one of the steps is performed by a processor.

In some cases, the method further comprises determining a reality program winner from the two or more contestants.

In some cases, the online web-course requires a registration to the online web-course.

In some cases, conducting the online web-course further comprises administering of an entrance examination to the group of registrants.

In some cases, conducting the online web-course further comprises issuing participation points to at least a portion of the group of registrants; wherein the participation points are issued for completion of a lecture component, for completion of an assignment component, and for completion of an exam component.

In some cases, choosing the two or more contestants of the reality program is performed automatically according the participation points.

In some cases, choosing the two or more contestants of the reality program is performed automatically according to the participation points and votes received for the group of registrants.

In some cases, the lecture component comprises connecting a content layer uploaded by the registrant to a media file chosen by the registrant.

The subject matter discloses a system comprising an online course server for administering an online web-course; a storage for storing data on the group of registrants; a processor for determining a group of contestants for a reality program from the group of registrants.

In some cases, the processor further issues participation points.

In some cases, the online course server connects a content layer uploaded by a registrant of the group of registrants to a media file identified by the registrant who uploaded the content layer.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a system for an online course and reality program, according to exemplary embodiment of the subject matter;

FIG. 2 shows a method for conducting an online course and reality program, according to exemplary embodiment of the subject matter;

FIG. 3 shows a method for choosing of a registrant to be a cast member on a reality program.

### DETAILED DESCRIPTION

The present subject matter discloses a method of choosing a predetermined number of contestants for a reality program from a group of registrants of an online web-course. A registrant from the group of registrants signs up for the online web-course in which the registrant is required to complete a predetermined number of tasks, for example, view and comment on lectures, complete online and offline assignments, and complete examinations. At the end of the online web-course, the contestants for the reality program are chosen from the group of registrants. Choosing the contestants may be performed according to several parameters, such as a quantity of participation points obtained by different registrants of the group of registrants and a vote. In some exemplary embodiments, the vote is conducted amongst the group of registrants. For example, the 20 registrants from the group of registrants with the most participation points and most votes are chosen as contestants on the reality program.

In some exemplary embodiments of the subject matter, after the contestants are chosen for the reality program, the contestants are required to compete against each other to win various prizes, for example by completing challenges. At the completion of each challenge or race, some of the contestants may be eliminated from the reality program until a last contestant remains and is chosen as a reality program winner.

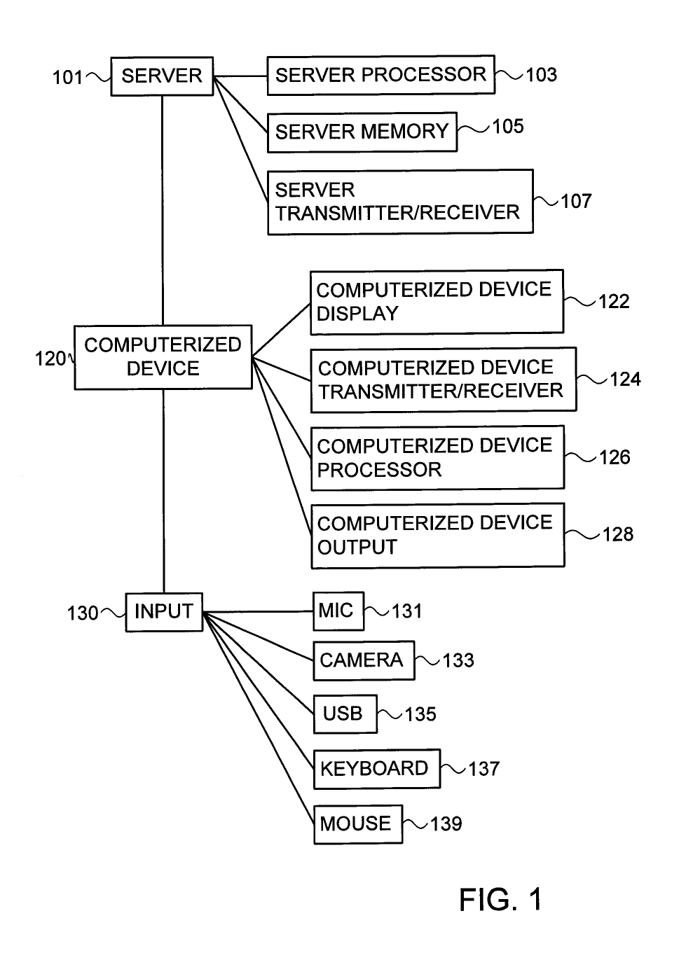

FIG. 1 shows a system for implementing an online web-course and a reality program, according to exemplary embodiment of the subject matter. The system comprises an online course server 101, which contains the data for the online web-course, connected to a computerized device 120, such as a laptop or mobile device. The computerized device 120 is used by a user, who may be by a registrant of the online web-course, an online web-course instructor, by a contestant on the reality program, a judge on the reality program, a viewer of the reality program, or a reality program conductor. The computerized device 120 comprises a display 122, which displays the content from the online web-course or from the reality program, for example a live streaming video during the online web-course lecture or a live streaming video of the elimination of a contestant from the reality program. The computerized device 120 comprises an audio output 128, which allows hearing audio content from the online web-course and from the reality program, for example the audio portion of the online web-course lecture, or the conversations held by the contestants of the reality program.

The computerized device 120 comprises an input device 130, which may be for example, a microphone 131, for collecting audio samples; a camera 133, for collecting video or image samples; a universal serial bus (“USB”) 135, for uploading data obtained from a different computerized device; a keyboard 137, for typing a text message; or a mouse 139, for inputting various commands. The input device 130 may be used by the registrant to complete the online web-course assignments, for example, collecting images of a completed assignment with the camera 133. The input device 130 may further be used by the registrant to participate in lectures throughout the online web-course, for example by adding content layers to the lecture media file. The content layers may comprise of data inputted by the registrant as well as registrant information, such as the registrant's name, e-mail, or image. Addition of content layers by registrants may incur participation points added to the registrant who added the content layers. Addition of content layers may be effective in choosing the contestants for the reality program from the group of registrants.

The computerized device 120 comprises a computerized device processor 126, which processes data received from the input device 130 or from a computerized device transmitter/receiver 124, which receives data from the online course server 101. The computerized device processor 126 designates the location to which the data is to be transferred to. For example, the computerized device transmitter/receiver 124 receives data from the online course server 101, such as a lecture media file, which is transferred by the computerized device transmitter/receiver 124 to the computerized device processor 126. The computerized device processor 126 interprets the data received from the online course server 101, processes the data and transfers the data to the display 122, which displays the visual elements of the data, and the audio output 128, which emits the audial elements of the data. In another example, an input is obtained by the input device 130, such as an audio sample recorded with the microphone 131 transferred from the microphone 131 to the computerized device processor 126. The audio sample is converted by the computerized device processor 126 into a desired format, such as converting the audio sample into a content layer. The data is transferred from the computerized device processor 126 to the computerized device transmitter/receiver 124, which transmits the data to the online course server 101.

The online course server 101 comprises a server transmitter/receiver 107, which receives data from the computerized device 120 of the user and transmits data to the computerized device 120 of the user. The server transmitter/receiver 107 may also receive streaming live media data from the computerized device 126 of one of the users, for example the computerized device 120 of the online web-course instructor. Data from the online web-course instructor may then be transmitted by the online course server 101 through the server transmitter/receiver 107 to other users logged onto the online web-course, not only registrants of the online web-course.

The data received by the server transmitter/receiver 107 is transferred to a server processor 103, which processes the data inputted by the user of the computerized device 120. In some exemplary embodiments of the subject matter, the server processor 103 may insert a content layer uploaded by the registrant of the online web-course or the contestant of the reality program. The server processor 103 may designate data, such as media files, the registrant's assignments, the registrant's user information and recorded live lecture media files to be stored in a server memory 105. The server processor 103 may retrieve content from the server memory 105, when the user requests it, for example the registrant of the online web-course desires to watch available lecture media files, the server processor 103 receives a command from the registrant's computerized device 120 to retrieve the stored lecture media file from the server memory 105 and to transmit it to the registrant's computerized device 120. The server processor 103 allows the online web-course instructor to change the online web-course environment by sending instructions and data relating to the online web-course environment to the online course server 101. For example, the online web-course instructor wants the online web-course to have a background resembling a bar environment, the online web-course instructor uploads to the online course server 101 an image of a bar which becomes the background the registrant sees when entering the online web-course.

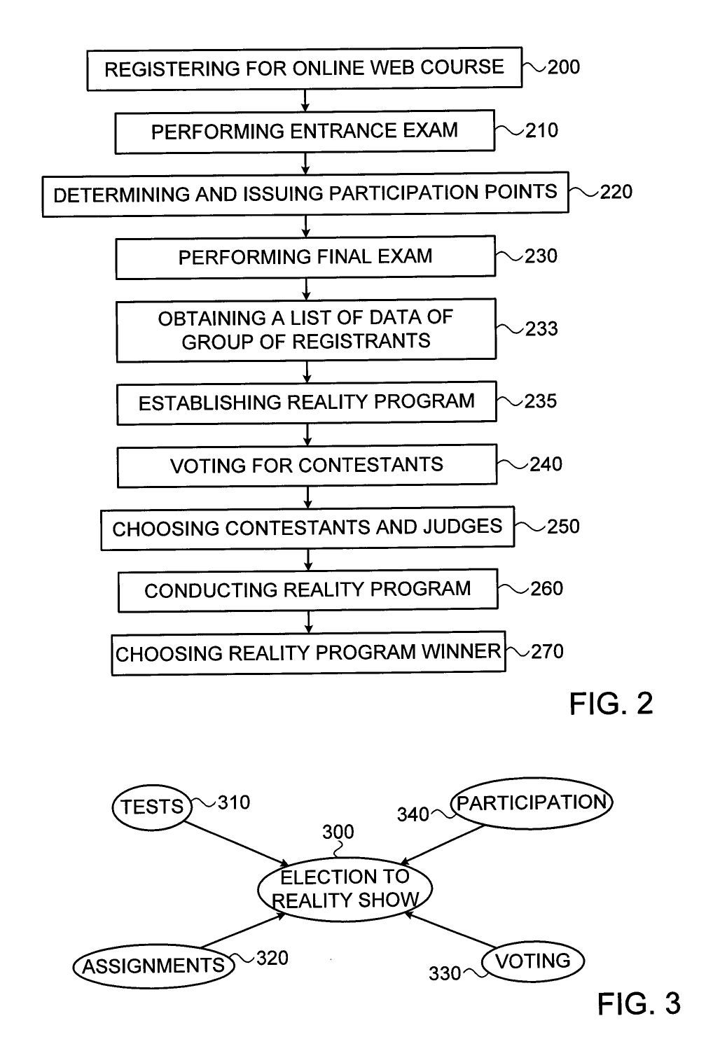

FIG. 2 shows a method for casting and conducting a reality program, according to exemplary embodiment of the subject matter. In step 200, registering for an online web-course is made available, for example to the public or to the group of registrants. In some exemplary embodiments of the subject matter, the online web-course may be accessed through the internet, where the registrant logs onto the online web-course, and signs up for the online web-course. Logging in may comprise, for example, creating a login username, password, and providing personal information, such as the registrant's name, date of birth, etc. The registrant's login username, password, and personal information are stored in the server memory 124 of FIG. 1, allowing the registrant to access the online web-course course throughout the duration of the online web-course and may allow access to the reality program.

Step 210 provides for administering an entrance exam to the group of registrants. The entrance exam may comprise a tutorial, which explains to the registrant from the group of registrants what is required in order to complete the entrance exam. It should be noted that step 210 is exemplary only and the method can be implemented without an entrance exam. The entrance exam and the tutorial may also serve as an introduction to the online web-course and as an explanation to the group of registrants what is expected in participating and completing the online web-course. The entrance exam may comprise a task that each registrant of the group of registrants must complete and then upload the completed work product onto the online course server 101 from FIG. 1. For example, the online web-course relates to house improvement, in which the registrant learns improved interior design etiquette. The registrant chooses a room in her house in which she will complete the entrance exam, for example a bedroom. The registrant obtains a “before” image of how the bedroom look before she redesigns the bedroom. The registrant then redesigns the bedroom according to the requirements of the entrance exam instructions and the tutorial. After redesigning the bedroom as required by the entrance exam instructions and the tutorial, the registrant obtains a photo of how the bedroom looks “after” the completion of the required task. The registrant uploads the “before” image and the “after” image to the online course server 101, where the online web-course instructor reviews the two images and decides if the results are acceptable and whether the registrant passed the entrance exam. If the registrant passed the entrance exam, she is allowed to participate in the online web-course and thus a candidate for the reality program. However, if the registrant's work product does not meet the required expectations, the registrant is not permitted to take the online web-course, and the registrant will have to try again at a later date.

Step 220 provides for determining and issuing participation points. The registrant gains participation points for various actions, such as completing tasks, which are part of the online web-course. The participation points are accumulated throughout the duration of the online web-course. The web-course comprises of several components which allow the registrant to earn participation points, such as a lecture component, an assignment component, and a test component. The lecture component comprises of lectures that may be live streaming media files, which require the registrant to log onto the online web-course during predetermined times to participate in the lectures. Other portions of the lectures may be previously prepared media files, which enable the registrant to view the lectures at any time. The registrant receives participation points for viewing the lecture media files and for uploading content layers, which offer commentary to the lecture media files. For example, the registrant is watching a live streaming lecture related to matching the curtains and the drapes in a living room of a house. The content layers uploaded by previous registrants are available for the registrant to view with the media file at the later times. In an exemplary case, the registrant has some samples of drape and carpet color she would like to share during the lecture. The registrant can upload a content layer comprising an image of the drapes and carpet she would like to share and have it appear at as part of the live lecture for the rest of the registrants viewing the lecture to see.

In some exemplary embodiments, the live lectures are available as prerecorded lectures once the live lecture is completed. However, a registrant that did not participate in the live lecture might not receive the total allotted participation points for viewing the lecture.

The assignment portion of the tasks requires the registrant to complete assignments, which are activities the registrant must complete in order receive participation points. The assignments may be completed online, while the registrant is logged onto the online web-course website, or the assignments may be completed offline and then the final results of the assignments uploaded to the online course server 101. In some exemplary embodiments of the subject matter, registrants may be allowed to work together in a group, in which case each has to show their participation in the work done, and the registrants are each issued the same quantity of participation points for the assignment. For example, the registrant works with a fellow registrant on an assignment instructing the registrant on how best to redesign the layout of a bathroom of a house. The registrants of the group of registrants have a predetermined time allotted to redesign a bathroom as required by the assignment. The assignment requires that the registrant record the entire process of redesigning the bathroom and then uploading the video to the online course server 101. The registrants of the group of registrants may use the camera 133 as the input device 130 of the computerized device 120 to record a video of the assignment; or the registrant may video record the assignment with a different camera device not connected to the computerized device 120, and then input the recorded video onto the computerized device 120 using the USB 135, which can be used to extract the video from the camera device and transfer it to the computerized device 120. Once the assignment is uploaded to the online course server 101, the online web-course instructor evaluates the work and issues the registrants the number of participation points the online web-course instructor believes the registrants deserves for the assignment.

In some exemplary embodiments of the subject matter, the assignment component may comprise of the registrant being designated a registrant page on a social network, for example, having a Facebook page. The registrant may then obtain participation points by receiving votes on the registrant page, such as receiving “likes” on the Facebook page. The registrant may be required to update the registrant page with the registrant's activities and receive voting for the posted activities. For example, the registrant updates his Facebook page with pictures of an assignment the registrant is completing. The registrant receives one participation point for every “like” he receives on his post.

Step 230 provides for performing a final exam, which may comprise of online and offline components. The final exam evaluates the registrant's comprehension of all the materials taught throughout the online web-course. For example, the online web-course is an interior house design and each assignment required the registrant to improve a different room in a house. The final exam would require the registrant to redesign an entire house to reflect the material taught during the online web-course. The registrant may be required to video tape the entire progress, or compile images of the progression of the house improvement. The registrant must show the progress of each room and the entire house as a whole project. At the end all of the progress material, either of video or images, is uploaded to the online course server 101 to be evaluated by the online web-course instructor. The online web-course instructor issues the participation points for the test component, which may have a determinative effect on whether the registrant excelled in the online web-course, for example, the final project is worth 50% of the participation points available.

Step 233 provides for obtaining a list comprising data of the group of registrants. The data in the list is compiled by the server processor 103 and is used to monitor the progression of the registrants in the group of registrants. The list may comprise the registrant's name, and accumulated participation points. When the registrant obtains participation points, for example for uploading content layers, the server processor 103 updates the number of participation points the registrant has. At the termination of the online web-course the online web-course instructor may use the list to choose the contestants of the reality program.

Step 235 provides for establishing a reality program. A reality program conductor chooses the theme for the reality program, which may comprise the subject taught in the online web-course. The reality program allows the registrants that are chosen as contestants to demonstrate the concepts and skills taught during the online web-course and in some exemplary embodiments receive prizes for the demonstrations.

In step 240, voting for the reality program contestants is administered. The reality program has a predetermined number of contestant slots available. In some exemplary embodiments, the voting is done amongst the group of registrants. Each registrant in the group of registrants may submit a registrant vote for a predetermined number of registrants, which the registrant wants to see perform on the reality program. For example, the total number of registrants in the online web-course is 50 registrants, and there are only 20 contestant slots on the reality program. Each registrant is given the opportunity to vote for 10 registrants, including the registrant herself, to be a contestant on the reality program. At the end of the voting, a reality program conductor choses the contestants for the reality program. In other cases, voting for the contestants is open to the public. The votes may be stored at a storage device.

Step 250 provides for choosing the reality program contestants. The reality program has a predetermined number of contestant slots available, for example 20 contestant slots. In some exemplary cases, the registrants with the highest number of accumulated participation points and the most votes are chosen into the contestant slots until all the contestant slots are filled. The voting may be administered so that the voting data is collected by a processor associated with the online course server 101, which determines the registrants from the group of registrants with the most participation points, the most votes, or a combination of both to be contestants on the reality program.

In some exemplary embodiments of the subject matter, registrants from the group of registrants that did not obtain a contestant slot on the reality program are given an option to officiate as judges on the reality program. The judges are responsible for determining if the contestants on the reality program should be eliminated or not depending on the contestant's ability to complete challenges on the reality program. For example, out of 50 registrants in the online web-course, 20 were chosen as contestants on the reality program. The remaining 30 registrants are offered an opportunity to be judges on the reality program. 12 of the 30 registrants agree and become judges on the reality program.

Step 260 provides for conducting the reality program with the contestants. The contestants participate in the reality program, which may now be available for viewing by viewers who were not registrants of the online web-course. In one exemplary embodiment of the subject matter, the contestants are required to complete new assignments and tasks while being video recorded. The contestants may be required to communicate with the audience and talk about their work and their thought processes. During the reality program the contestants may interact with the judges and other viewers of the reality using live chats, which may be done in video, audio, text or a combination of the three. After every assignment, the judges, along with the reality program conductor, may eliminate a contestant who is voted as having done the least satisfactory work on the assignment. For example, the contestants are given an assignment to design the lighting of a bedroom in a manner specified by the instructions of the assignment. After the contestants complete the assignment, they are judged by the judges and the reality program conductor. The judges and the reality program conductor judge the contestants' performance and completed assignment results. The judges and the reality program conductor vote for the contestant who did the least satisfactory work. The contestant with the most votes against her is being removed from the contestants on the reality program.

In some exemplary embodiments, the contestant has to maintain the registrant page that was assigned to the contestant during the online web-course. The contestant continues being responsible for updating and maintain the registrant page, which will have an effect on the contestant's standing in the reality program. For example, if the contestant continually maintains the registrant page and receives votes for the page and the updates, the contestant may receive immunity from being eliminated from the reality program for a predetermined length of time. If the contestant fails to update the registrant page and receive votes for the page and the updates, the contestant may be at a higher risk of being eliminated from the reality program.

In step 270, a reality program winner is determined. After all of the challenges have been completed and all but several of the contestants have been eliminated by the judges, a final challenge is presented to the remaining contestants of the reality program, in which the contestant that does not get eliminated is designated as the reality program winner. For example, the last 3 contestants that have not been eliminated are assigned the final challenge of redesigning the interior of a large mansion. The contestants compete and are judged by the judges and the reality program conductor on the results of the contestants work. Two of the contestants are eliminated and the contestant who is not eliminated is designated the reality program winner.

FIG. 3 shows a method of choosing the registrants to become a contestant on the reality program 300, according to exemplary embodiments of the disclosed subject matter. Choosing the registrants as contestants may require the registrants to obtain as many participation points possible and receive a majority of the registrant votes. The registrant obtains participation points for a participation component 340, which comprises viewing lectures, and commenting on the lectures. The registrant views prerecorded lecture media files, which are available on the online web-course to receive participation points for the participation component.

Some of the lectures require attendance at a predetermined time. These lectures may be live lectures where the lecture media is streamed from an instructor who inputs the lecture into the input device 130 of the computerized device 120 at the location the instructor is lecturing. The lecture is transmitted by the computerized device 120 to the online course server 101, which transmits the lecture for the registrant to view on the computerized device 120 at the registrant's location. To receive the full amount of participation points, the registrant must view the lecture at the predetermined time. In some exemplary embodiments, the live lecture are be stored in the server memory 105 and available for viewing and receiving of a portion of the participation points by registrants that did not view the lecture while it was streaming.

As part of the lecture component the online course server 101 may connect content layers to the media file chosen by the registrant. The registrant may receive participation points for the content layers. In some exemplary embodiments the registrant is capable of accumulating sufficient participation points through connecting content layers to be chosen as a contestant on the reality program.

In some exemplary embodiments the participation component 340 comprises of uploading content layers to the lecture media files so as to receive participation points. The content layers comprise of additional information that the registrant adds to be viewed in tandem with the lecture media file. The more content layers the registrant uploads, the more participation points the registrant may accumulate.

Participation points may also be acquired from a test component 310, in which the registrant is required to excel in examinations. The examinations may comprise of activities that test the knowledge the registrant has acquired through the progression of the online web-course. In some exemplary embodiments the test component 310 may comprise of multiple exams, or in other exemplary embodiments there may only be one final exam. For example, the registrant must complete the final exam, which may require the registrant to integrate all of the concepts taught throughout the online web-course.

The registrant obtains participation points from an assignment component 320, in which the registrant must complete projects and activities that practice the concepts taught in the lectures. For example, in one of the lectures the instructor explains the importance of spacing in a living room, and the assignment requires the registrant to reorganize a living room based on the concepts taught during the lecture. The registrant collects images that represent her work or she may video record her work using the camera 133 and upload the work onto the online course server 101. The instructor reviews the work and assigns participation points according to the excellence of the work.

The assignment component 320 may also comprise of maintaining a registration page on a social network assigned to the registrant at the beginning of the online web-course. The registrant updates the registrant page and receives votes for the registrant page and the updates made to the page. The participation points may be designated so that for every vote the registrant page and the updates receive, the registrant receives a participation point.

At a predetermined time of the online web-course there is a registrant voting 330. The registrant voting is used in tandem with the participation points to determine which registrants from the registrant group becomes a contestant on the reality program. In some exemplary embodiments, the registrant must receive a quorum of votes submitted so as to be chosen for the reality program. This requires the registrant to create friendly relationships with other registrants in the online web-course, which will ensure getting the registrant votes needed. For example, 50 registrants participated until the completion of the online web-course. Each one of the 50 registrants submitted a registrant vote to choose 10 of the registrant to be contestants in the reality program. A registrant wanting to be chosen would need to a majority of the registrant votes to be chosen to perform on the reality program.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method comprising:
conducting an online web-course between an instructor and a group of registrants;
obtaining a list comprising data of the group of registrants;
establishing a reality program to be broadcasted, said reality program includes two or more contestants;
choosing the two or more contestants for the reality program from the group of registrants, wherein at least one of the steps is performed by a processor.

2. The method of claim 1, further comprises determining a reality program winner from the two or more contestants.

3. The method of claim 1, wherein the online web-course requires a registration to the online web-course.

4. The method of claim 1, wherein conducting the online web-course further comprises administering of an entrance examination to the group of registrants.

5. The method of claim 1, wherein conducting the online web-course further comprises issuing participation points to at least a portion of the group of registrants;
wherein the participation points are issued for completion of a lecture component, for completion of an assignment component, and for completion of an exam component.

6. The method of claim 5, wherein choosing the two or more contestants of the reality program is performed automatically according the participation points.

7. The method of claim 5, wherein choosing the two or more contestants of the reality program is performed automatically according to the participation points and votes received for the group of registrants.

8. The method of claim 5, wherein the lecture component comprises connecting a content layer uploaded by the registrant to a media file chosen by the registrant.

9. A system comprising:
an online course server for administering an online web-course;
a storage for storing data on the group of registrants;
a processor for determining a group of contestants for a reality program from the group of registrants.

10. The system of claim 9, wherein the processor further issues participation points.

11. The system of claim 9, wherein the online course server connects a content layer uploaded by a registrant of the group of registrants to a media file identified by the registrant who uploaded the content layer.
